(19) United States
(12) Patent Application Publication
(10) Pub. No.: US 2006/0289690 A1
(43) Pub. Date: Dec. 28, 2006

(54) Bait casting reel and method

(76) Inventors: Jeffrey D. Marsh, Foristell, MO (US); Leonard DiCarlo, University City, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/141,912

(22) Filed: Jun. 1, 2005

(51) Int. Cl. A01K 89/00

(52) U.S. Cl. 242/282

(57) ABSTRACT

A fishing reel (such as a bait casting reel) is disclosed in which the bearings for both the drive shaft and the output shaft of a speed increasing gear train are carried solely in the side cover of the reel and in which the end of the spool shaft proximate the gear train is journaled solely by the reel frame with a coupler coupling the output shaft and the spool shaft such that within a limited range, variances in axial dimensions (positions) and in angular alignment between the spool shaft and the output shaft may be readily accommodated. In another embodiment, the drive shaft, the output shaft and the spool shaft are journaled solely with respect to the reel frame. A cast control is disclosed which eliminates the need for an elongated spool shaft and which is adjustable over a wide range. A method of accommodating such variances and misalignment is also disclosed.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

This invention relates generally to fishing reels, and more specifically to the construction of a bait casting reel which lessens the criticality of dimensional tolerances of the components of the reels and results in a reel which is easy to manufacture, which is less expensive to manufacture, which is more readily assembled both in the factory and by users in the field, and which runs more quietly and casts farther than past reel designs.

Typically, a bait casting reel has a spool on to which is wound a length of fishing line. In order to wind the line onto the spool, the reel is provided with a handle operated by the person using the reel. A speed increasing gear train (e.g., a drive gear and a pinion) is driven by the turning of the handle so that the spool rotates at a speed significantly faster than the speed at which the handle is turned. Typically, the speed-increasing ratio is about 6:1. The reel has a frame in which the spool is mounted and side covers secured to each side of the frame so as to enclose the gear train and other reel components. Bait casting reels are typically provided with a thumb bar or the like that allows the fisherman to disconnect the spool from the gear train and the handle during casting. When the line has been fully wound in and the lure attached to the end of the line is in proper position to cast, the fisherman operates the thumb bar to operatively disconnect the spool from the gear train. After the thumb bar has been operated, the fisherman holds the spool stationary with his thumb and draws the lure and the rod behind him and then abruptly casts the rod forward so as to give the rod a whipping action. At a critical point during the cast, the fisherman removes his thumb from the spool allowing the energy imparted to the lure by the rod during the cast to pull line from the spool. The inertia of the lure causes the spool to rapidly accelerate. The spool will oftentimes be accelerated to angular velocities in excess of 15,000 rpm and accelerations in excess of 700 m/s² thus imparting significant forces on the reel. As the fisherman begins to operate the handle to retrieve the line, the gear train is automatically engaged so that the spool will be rotated to wind line onto the reel.

Typically, the gear train, handle, and spool are journaled with respect to the frame and the side covers by means of suitable bearings, preferably ball bearings. It has been found that the tolerances for the bearings and for the bores in the frame and the side covers that receive the bearings must be very tight in order to maintain the gears of the gear train in proper mesh and in order to prevent binding of various shafts in the reel. Of course, the requirement of tight tolerances makes the reel a precision instrument and increases the cost of the reel to manufacture and to assemble. Also, tight tolerances result in a larger percentage of the components for the reel to be rejected because they do not meet the tolerance specifications. These rejected parts result in higher cost for the reel.

Many prior art reels have a cast control that allows the user to adjust a frictional drag force applied to the spool during so as to minimize the tendency of the inertia of the rotating spool during a cast to unwind excess line from the spool after the lure has landed thereby to inhibit the formation of line tangles (referred to as “backlashes”). In addition to such cast controls, reels are often provided with a centrifugal braking system to also inhibit the formation of backlashes. Typically, the cast control includes an adjustment knob that may be operated by the user to increase or decrease the drag placed on the free wheeling spool. These cast controls were typically located on the side of the reel on which the handle is provided. Such prior art cast controls operated on an elongated spool shaft extension. Such elongated spools shafts were typically journaled by three bearings. Usually, two of these bearings were mounted in the reel frame (or in a screw cap secured to the reel frame) at opposite ends of the spool, and one of the bearings journaled the elongate spool shaft extension relative to a side cover. With the bores receiving these bearings being located in the reel frame and the side cover, it has been necessary to control the dimensions and axial positions of these bores to a high degree of accuracy so as to insure proper rotation of the spool without undue binding or noise. Also, this arrangement required the precision machining of these bores and the precision mounting of the side cover on the frame. It has also been discovered that, due to the high acceleration forces exerted on the spool shaft during a cast, the elongate spool shaft would experience multi-plane whipping actions thus resulting in bending and consequent binding of the shaft during the cast (which decreased casting distance) and resulted in unwanted noise.

As previously noted, prior art cast control adjustment typically operated on the end of the elongated spool shaft. This elongated spool shaft extension extended axially through an axial bore in the pinion shaft for engagement by the cast control. Thus, this spool shaft extension served to journal the pinion. This often resulted in additional binding of the spool shaft and further required a precision fit of the spool shaft within the axial bore of the pinion shaft so as to be properly fit with the cast control. Of course, if the elongate end of the spool shaft is not properly received in the bore of the pinion shaft or if there is a slight angular misalignment between the elongate spool shaft and the pinion shaft bore, binding of the spool shaft will result, particularly if the above-described multi-plane whipping during casting is experienced. Additionally, since the elongated spool shaft extension not only supports the spool, but also serves to mount the pinion, any inaccuracy of the mounting of the spool shaft would prevent the proper mesh of the pinion and its drive gear. This was found to result in unwanted gear noise when the handle was operated to wind line onto the spool.

Typically, such prior art reels typically have a line leveler operatively driven upon operation of the reel handle. Line is threaded through the line leveler such that upon winding line onto the spool, the line leveler reciprocates back and forth as line is wound onto the spool so as to wind line on to the spool in a level fashion. However, upon casting, the line leveler remains stationary in whichever position it was when the thumb bar was operated such that as the line is cast, the line tracks left and right so as to be fed through the line leveler. This imposes alternating axial thrust loads on the spool during casting that must be reacted by the spool bearings. Again, if the bearings are not accurately located in their respective mounting positions in the frame or side covers with a high degree of accuracy, unwanted noise and vibration will result as these alternating side thrust loads are transmitted through the spool to is bearings.

There has been a long-standing need for a fishing reel design that minimizes the complexity of the gear train and spool design, that minimizes the need for close tolerances of the components of the reel, that eliminates the need for an elongate spool shaft, and a less complex design that lowers the manufacturing and assembly costs of such reels and that results in a smoother and quieter operating reel. The invention(s) described by the claims herein is intended to overcome some or all of the above-described problems or shortcomings of the prior art reels.

### SUMMARY OF THE INVENTION

Among the many objects and features of a reel embodying at least some of the features of this invention may be noted the provision of a reel which has a side cover secured to the reel frame where the bearings that journal (support) a handle, a handle (drive) shaft, a gear train, and an output shaft of a gear train with all of these components journaled only relative to either the frame or the side cover such that the bores receiving the bearings journaling these components need only be machined relative to one member thereby facilitating the machining of these bores and minimizing the need to precision match the bores in both the frame and the side frame receive these bearings;

A reel in which the output shaft of the gear train is connected to the spool shaft in such manner as to accommodate axial and angular misalignment and dimensional variances between the pinion shaft and the spool shaft, and yet which allows the spool and the pinion to freely rotate without binding and to be disconnected from the spool for casting;

A reel having a cast control which is operable on the side of the reel opposite the handle thereby eliminating the need for an elongate spool shaft;

A reel in which it is not necessary for the spool shaft to extend axially through the pinion shaft for engagement by a cast control friction member;

A reel having a cast control that is operable with the spool through a wide range of axial variances of the spool with respect to the frame and that is readily adjustable by the user of the reel; and

A reel that is relatively easy to machine, assemble, and operate, that is economical to manufacture, and that is reliable in operation and has a long service life.

In one embodiment of a fishing reel of this invention, the reel has a frame, a side cover, a spool on which a supply of line is wound, and a speed increasing gear train for rotatably driving the spool for winding line onto the spool. The reel has a handle shaft operated by a handle. The gear train includes a drive gear mounted on the handle shaft, a pinion in mesh with the drive gear, and a pinion shaft on which the pinion is mounted. Both the handle shaft and the pinion shaft are journaled solely with respect to the side cover, or solely with respect to the frame. The pinion shaft is operatively connected to the spool so as to accommodate within a limited range dimensional variances and angular misalignments of the pinion shaft and the spool.

This invention also involves a method of driving a spool of a fishing reel. In one embodiment of this method, a spool rotatably is mounted in a frame. The spool is driven by a gear train having an input shaft, a drive gear, a pinion, and an output shaft where axial misalignment and dimensional variances between the input shaft and the output shaft are controlled only with respect to a cover. The method comprises the steps of journaling the input shaft solely with respect to the side cover, journaling the output shaft solely with respect to the frame or solely with respect to the side cover, and coupling the output shaft and the spool so as to accommodate, within a limited range, dimensional variances and angular misalignments between the output shaft and the spool.

Alternatively, this method may comprise the steps of journaling the input shaft solely with respect to the frame, journaling the output shaft solely with respect to the frame or solely with respect to the frame, and coupling the output shaft and the spool so as to accommodate, within a limited range, dimensional variances and angular misalignments between the output shaft and the spool.

This invention may also involve a reel having a cast control, which is operable on the end of the spool shaft opposite the side of the reel having the handle. The cast control includes a friction member adjustably engageable with the spool shaft. The friction member is resiliently biased into engagement with the spool shaft so that dimensional variances between the end of the spool shaft and the friction member are readily accommodated over a relatively wide range of adjustment.

Other objects and features of the reel of this invention will be in part apparent and in part disclosed hereinafter. It will be understood that all of the above objects and features need not be embodied in all of the claims of any patent issuing on this disclosure.

For a better understanding of the present invention, together with other and further objects thereof, reference is made to the accompanying drawings and detailed description and its scope will be pointed out in the regular and appended claims.

### BRIEF DESCRIPTION OF THE DRAWINGS

FIG. 1 is a cross sectional view of a typical prior art reel having a frame, a side cover, a handle, a handle shaft, a speed increasing gear train, a pinion, a pinion shaft, a spool, and a spool shaft, where the bearings journaling the input shaft, the output shaft and the spool shaft are mounted in both the frame and the side cover;

FIG. 2 is an end view of a portion of one exemplary embodiment of a reel of the present invention, where, in the foreground, a fragmentary portion of a side cover secured to the reel frame opposite the reel handle is shown having a screw cap that may be removed from the reel so as to permit insertion or removal of the spool from the reel and further illustrating a flip-up tab for adjusting a cast control;

FIG. 3 is a cross sectional view taken along line 3-3 of FIG. 2 illustrating the primary components of one embodiment of a reel of the present invention showing that the input shaft and the output shafts of a speed increasing gear train are journaled in bearings mounted solely within a side cover adapted to be removably secured to the reel frame on the side of the reel proximate the handle and illustrating how the reel spool is journaled and operatively connected to the gear train so as to minimize the criticality of tolerances and dimensions, and illustrating details of the cast control that is operable on the end of the spool shaft on the side of the reel opposite the reel handle;

FIG. 4 is a semi-diagrammatic view of a reel frame which journals the handle shaft, the pinion shaft, and the spool shaft so that the bores for receiving bearings that journal these shafts may be machined in a single part (the frame) thereby to facilitate the machining of these bores so as readily maintain axial alignment of the bores and thereby to maintain the spacing of the axes of these shafts within predetermined tolerances only with respect to the frame;

FIG. 5 is a longitudinal cross sectional perspective view taken along the spool axis and along the handle axis illustrating the components of the embodiment of FIG. 3; and

FIG. 6 is an enlarged view taken along line 6-6 of FIG. 5 illustrating details of the drag assembly.

Corresponding reference characters indicate corresponding parts throughout the several views of the drawings.

### DETAILED DESCRIPTION OF PREFERRED EMBODIMENTS

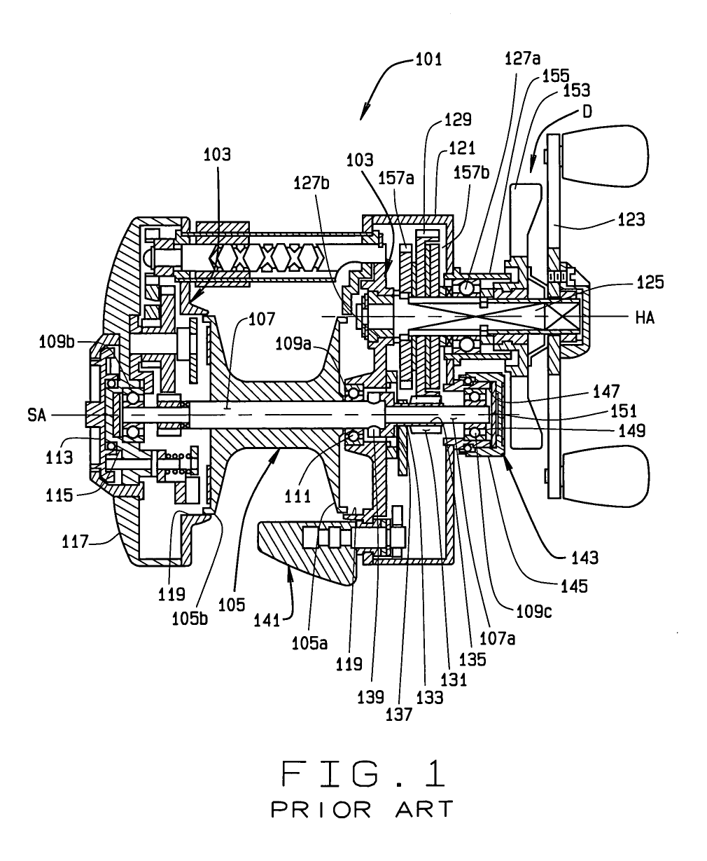

Referring now to FIG. 1, a typical prior art bait-casting reel is depicted in its entirety at 101. The reel 101 has a frame 103 and a spool 105 mounted for rotation within the reel about a spool axis SA. The spool has a spool shaft 107 coaxial with the spool axis SA. As shown in FIG. 1, the right-hand end of spool shaft has an integral spool shaft extension 107a for purposes as will appear. The spool shaft 107 and its extension 107a are journaled in three ball bearings 109a, 109b, and 109c. Bearing 109a is mounted on spool shaft 107 adjacent the end of the spool facing the handle side of the reel. Bearing 109a is received in a bore 111 in frame 103 adjacent the spool. Bearing 109b is carried by a screw cap 113 that is threadably received on a threaded boss 115 integral with a side cover 117 on the side of the reel opposite the handle. Of course, side cover 117 is threaded into frame 103. Spool 105 has spool flanges 105a, 105b at each end. These spool flanges have a close fit within a spool bore 119 in frame 103 so as to prevent fishing line wound on the spool from entering the gap between the outer edges of the spool flanges 105a, 105b and the edges of spool bore 119. The spool thus may be inserted endwise into (and removed from) reel frame in axial direction and so that the spool may freely rotate. The outer end 107a of the spool shaft 107 is received in bearing 109c mounted in a side cover 121 that is removably secured to frame 103 by means of screws or the like (not shown) so as to enclose the handle-side of the reel. Of course, the opposite side of the frame is enclosed by side cover 117 that is held in place by screw cap 113 such that the side cover 117 is secured in place with respect to frame 103.

It will be particularly noted that the spool shaft bearings 109a, 109b, and 109c are carried by three different parts, namely, frame 103, screw cap 113, and side cover 121. This has presented problems in the past in insuring that the bores receiving these bearings in the three different parts are accurately aligned and spaced relative to one another and problems were experienced upon inserting the elongate spool shaft 107a into its bearing 109c and upon inserting bearing 109a into its bore 111 so that spool 105 was free to rotate during casting and line retrieval.

A handle 123 is provided which is operable by the user so as to rotatably drive the spool such that line may be wound onto spool 105. Handle 123 is affixed to a handle shaft 125 journaled in suitable bearings 127a, 127b. As illustrated in FIG. 1, bearing 127a is preferably a suitable ball bearing mounted in side cover 121 and bearing 127b is a bushing carried by reel frame 103. Oftentimes, bait-casting reels will have a one-way clutch roller bearing (not shown) journaling the handle shaft so as to prevent the handle from being operated in a direction to unwind line from the reel.

A drive gear 129 is mounted on handle shaft 125 by a friction drag assembly D such that under normal conditions, the drive gear rotates with the handle shaft. However, upon a sufficient force being applied to the line wound on the spool, as by a fish pulling on the line, the drive gear will slip relative to the handle shaft thereby to allow line to be unwound from the spool. Drive gear 129 is in mesh with a pinion gear 131 fixedly mounted on a hollow pinion shaft 133. The pinion shaft has an axial bore 135 therethrough. As shown in FIG. 1, spool shaft extension 107a is received in pinion bore 135 such that the spool shaft also serves mount the pinion shaft. As noted, the right-hand end of spool shaft 107 is supported by bearing 109a mounted in the reel frame 103 and the spool shaft extension is journaled by bearing 109c mounted in side cover 111. Thus, there has been a long-standing problem in maintaining proper mesh between the drive gear 129 and pinion 131 and it has been difficult to insure that the spool shaft 107a turns freely within pinion bore 135. As indicated at 137, the inner end of pinion shaft 133 has a coupler formed thereon having notches (not shown) in its end facing spool 105 for releasably engaging a pin 139 extending radially through spool shaft 107 proximate the handle end of spool 105. The pinion shaft 133 may be shifted axially by a thumb bar mechanism 141 so as to slide the coupler 137 out of engagement with pin 139 thereby to disconnect spool 105 from pinion 131. By actuating thumb bar mechanism 141 and upon casting, the spool is free to turn in its bearings such that during a cast, the drive gear train and the handle are disconnected from the spool. Upon completion of the cast, operation of handle 123 effects axial movement of the coupler 137 so that coupler 137 reengages pin 139 such that operation of the handle will rotate the spool so as to wind line onto the spool.

As shown in FIG. 1, the right-hand end of spool shaft extension 107a is engageable by a cast control as generally indicated at 143. Such cast controls apply a friction force on the end of spool shaft extension 107a so that during the final phase of a cast as the lure hits the water, the momentum of the rotating spool 107 does not cause the spool to overrun and to unwind excess line that forms a backlash or other line tangle. Cast control 143 includes an adjustment cap 145 threadably mounted on a boss 147 carried by side cover 111. A flexible friction plate 149 is disposed between the inner face of cap 145 and the outer end of spool shaft 107 such that upon rotatably adjusting the cap relative to the threaded boss 147, an axial friction load or force may be applied to the outer end of the spool shaft extension 107a. This friction force is applied to the outer end of the spool shaft by friction plate 149 so as to impede overrunning of the spool, as described above. A recess 151 is provided on the inner face of cap 145 such that as the cap is threaded onto boss 147 to apply additional axial force to the end of spool shaft 107a, the friction plate may deflect outwardly into this recess so as to, within a limited range, apply a resilient friction force on the end of the spool shaft. In certain prior art a reel using casting controls, such as described above, it has been difficult to incrementally increase or decrease the amount of friction force applied to the spool shaft. This difficulty in adjustment is due to the fact that the flexible friction member will be completely clear of the end of shaft extension 107a or applying a maximum force upon turning cap 145 through less than a turn.

As previously noted, it is conventional to provide bait casting wheels with an adjustable friction drag assembly D. Such friction drag assemblies typically include an adjustable star-shaped wheel 153 threadably mounted on a boss 155 coaxial with handle axis HA. The handle shaft 125 extends out beyond the outer end of boss 155 and the star wheel is mounted between the end of the boss and handle 123. As is typical, drive gear 129 is not affixed to handle shaft 125, but rather is held fixed to the handle shaft by means of a friction clutch assembly including friction plates 157a, 157b. The outermost friction plate 157a is shown to be fixedly mounted to handle shaft 125, and the innermost friction plate 157b abuts the side cover 121, with the drive gear 129 frictionally squeezed between the friction plates 157a, 157b. The axial compression force applied to the friction plates and thus to the drive gear may be adjusted by tightening or loosening the star drag wheel 153. In this manner, the friction drag assembly D may be set such that when a predetermined level of force is applied to the line wound onto spool 105 by, for example, a fish hooked onto the line, the drive gear will thus become uncoupled from the handle shaft thus allowing line to be unwound from the spool. In this manner, the fish is inhibited from applying a sufficient force to the line which would be in excess of a predetermined amount thereby to lessen the tendency of a fish to break the fishing line. Also, even though the fish may unwind line from the spool, the friction drag will maintain a desired level of force on the line so that while a fish may with draw line from the spool, but such that a substantially constant force will be maintained on the line. This, of course, tends to tire out the fish.

Because in prior art reels, such as described above, the handle shaft 124 and the spool extension 107a that carries pinion 131 are mounted in bearings carried by both the side cover 121 and the frame 103, and because the side cover is removably mounted on the frame, very tight tolerances and high degrees of shaft and bearing angular alignment and parallelism were required for the bores receiving the bearings and for the mounting of the side cover on the frame. Even then, because of “stacking” of dimensional tolerances, dimensional variances were experienced that oftentimes resulted in undesired noise and roughness in the operation of the reel or that impaired casting. Oftentimes, these prior art reels that were expensive to machine and difficult to assemble. Specifically, because the elongate spool shaft was journaled in three bearings and because the spool shaft end 107a was received within the pinion bore 135, it was difficult and sometimes time consuming to so assemble such reels. Also, with such prior art cast controls, there was a necessity to provide an elongate spool shaft 107a that extended through the pinion shaft 133 and that was journaled by bearings 109a and 109c carried by both the reel frame 103 and the side cover 121 making it difficult to maintain alignment of the elongate spool shaft. Also, such prior art cast controls were sensitive to adjustment of the cap 145 such that they were difficult to incrementally increase or decrease the drag imposed on the spool shaft.

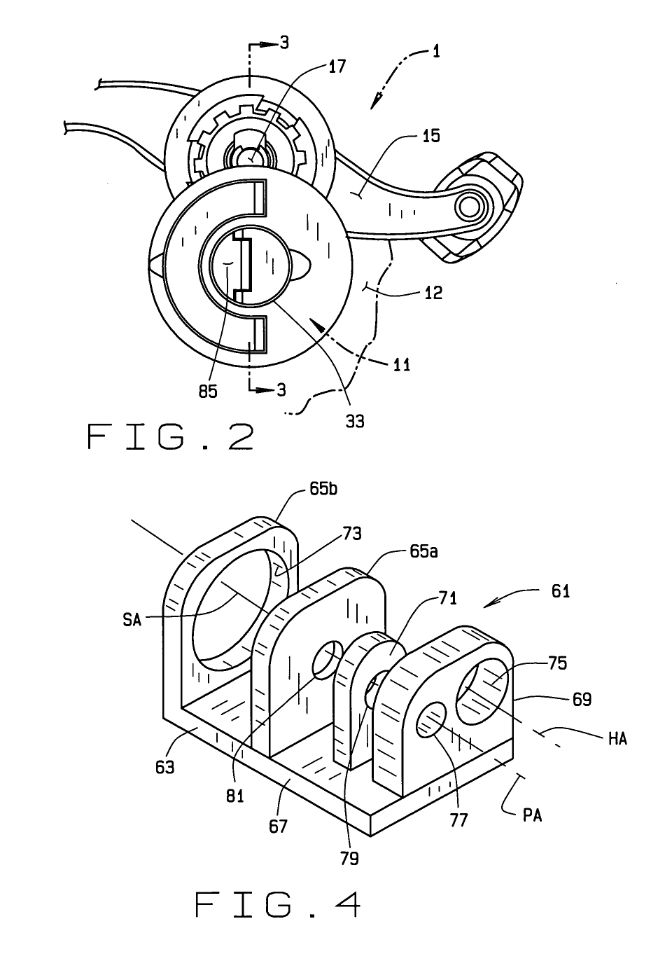

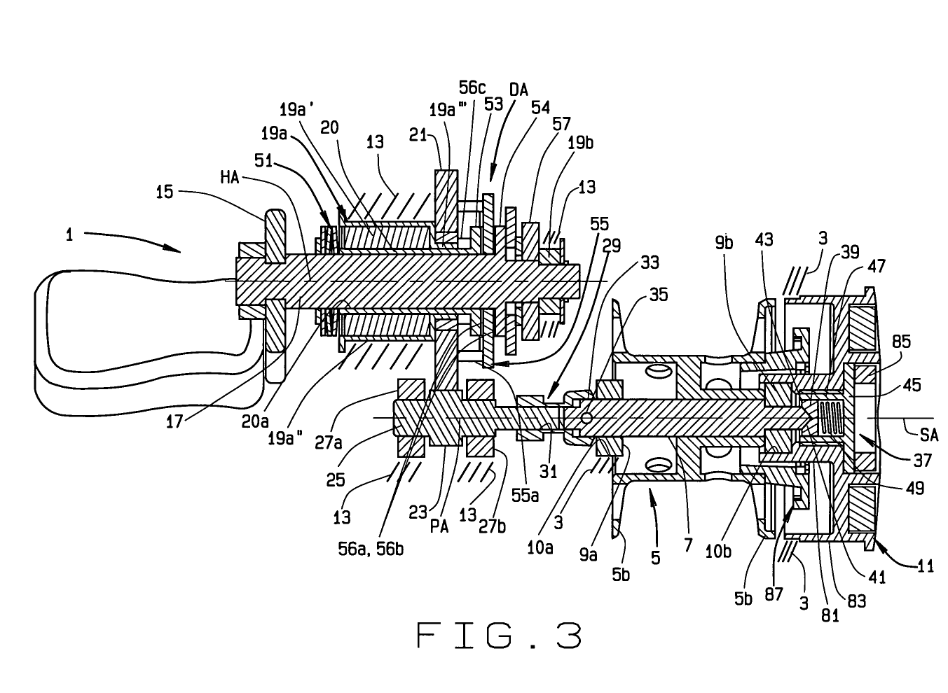

Referring now to FIGS. 2, 3 and 5, one embodiment of a reel embodying at least some of the features of the present invention is illustrated in its entirety by reference character 1. The reel has a frame 3 (only parts of which are shown in cross-hatching in FIG. 3 for purposes of clarity). A spool 5 is rotatably mounted within frame 3. The spool has side flanges 5a, 5b for holding a quantity of fishing line on the spool. Further, spool 5 has a spool shaft 7 with the axis of the spool shaft constituting a spool axis SA (see FIG. 3). Spool shaft 7 is journaled in spool bearings 9a, 9b. As shown in FIG. 3, spool bearing 9a is mounted a bore 10a in frame 3, and spool bearing 9b is mounted in a bore 10b in a screw cap 11 threadably secured to frame 3 on the side of the reel opposite the handle, as will be described in greater detail hereinafter. As generally indicated at 12 in FIG. 2, a side cover surrounds screw cap 11 and is removably secured to reel frame 3 so as to enclose that side of the reel and the components therein.

The term “journaled”, as used herein, means that a member is rotatably mounted and/or is supported by any suitable bearing, including a sleeve bearing, a journal bearing, or, preferably (but not necessarily), an antifriction bearing. An “antifriction” bearing is generally understood by those skilled in the art to include a class of bearings in which the load is transferred through elements in rolling contact rather than sliding contact. Thus, the term antifriction bearing includes, but is not limited to, ball bearings, roller bearings, and tapered roller bearings. As shown in FIG. 3, spool shaft 7 is journaled by ball bearings 9a, 9b, but those skilled in the art will recognize that within the broader aspects of this invention, any suitable bearing may be used.

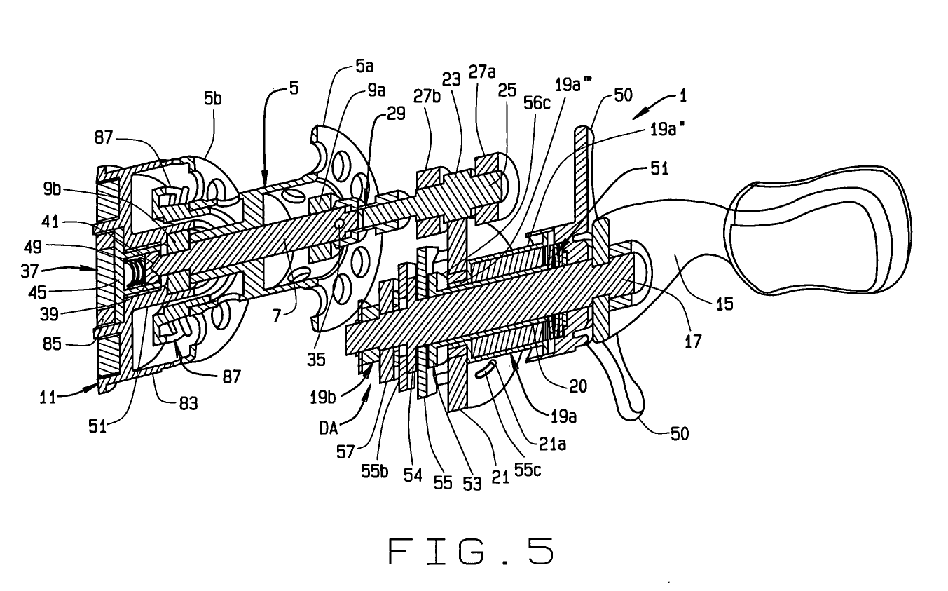

Frame 3 has another side cover 13 removably secured thereto. While the full structure of side cover 13 is not illustrated in FIG. 2 for purposes of clarity, portions of side cover 13 and frame 3 mounting the bearings and other critical components of the reel are illustrated by cross section hatching in FIG. 3. A handle 15 is provided which may be operated (turned) by the user. The handle is affixed to a handle shaft 17. As shown in the embodiment illustrated in FIG. 3, handle shaft 17 is journaled in handle shaft bearings 19a, 19b that are carried solely by the side cover 13. In the embodiment illustrated in FIG. 4, the handle shaft is journaled by bearings 19a, 19b that are carried solely by frame 3. The handle shaft 17 has a handle shaft axis HA. Preferably, bearings 19a, 19b are antifriction bearings, but those skilled in the art will recognize that in accordance with this invention, other types of bearings (as described above) may be used. As shown, bearing 19a is preferably (but not necessarily) a one-way clutch roller bearing that not only journals the handle shaft relative to the side cover, but the one-way clutch prevents rotation of the handle shaft in a direction that will unwind line from spool 5. It has been found that if an enlongated one-way clutch roller bearing is used (as shown in FIG. 3), it may not be necessary to provide a second bearing for the handle shaft, as indicated at 19b. In other words, bearing 19b may be omitted. This is further illustrated in FIG. 4, as hereinafter described.

A drive gear 21 is mounted on handle shaft 17. As will be explained in detail below, drive gear 21 is held in a fixed relation relative to shaft 17 by a friction drag assembly DA. The drive gear is in mesh with a smaller pinion gear 23 that is affixed to a pinion shaft 25. Drive gear 21 and pinion 23 are preferably helical gears. Drive gear 21 and pinion 23 thus form a speed increasing gear train where handle shaft 17 constitutes an input or drive shaft and pinion shaft 25 constitutes the output or driven shaft of the gear train. Bearings 27a, 27b journal pinion shaft 25 are received in bores formed on side cover 13 and thus journal the pinion shaft solely with respect to side cover 13. Heretofore, prior art pinion shafts had a pinion shaft axis PA, which (as shown in FIG. 1) is coaxial with spool axis SA. However, in accordance with at least certain of the objects of this invention, it will be noted that misalignments between the pinion axis PA and the spool axis SA may, within a limited range, be accommodated by a coupler 29. This will be further described below.

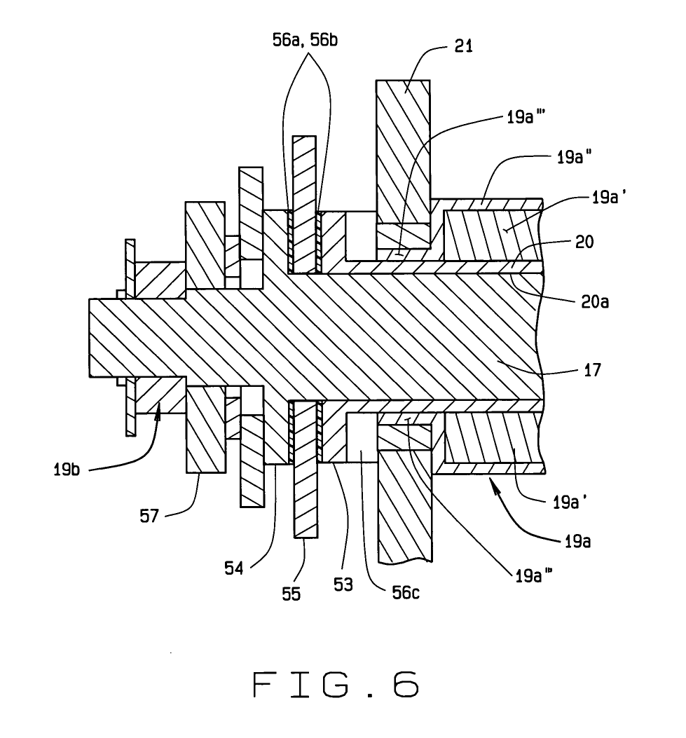

As generally indicated at DA in FIGS. 3 and 5, a drag assembly is provided on handle shaft 17 so that with one-way clutch 19a preventing rotation of the handle shaft in a direction so as to unwind line from spool 5, slippage of the drive gear 21 with respect to handle shaft 17 is permitted when a sufficient back driving force is applied as to result in line being pulled from spool 5, such as when a fisherman is fighting a fish, so as to permit line to be unwound from spool 5. In effect, the drag assembly allows rotation of the spool in reverse direction even though the one-way clutch prevents rotation of the handle shaft in the direction that would allow line to be unwound from the spool. Drag DA includes a star wheel 50 (see FIG. 5) threadably mounted on handle shaft 17. As the star wheel is threadably tightened (i.e., screwed axially inwardly with respect to handle shaft 17), an inwardly extending portion of the star wheel engages a stack of Belleville washers, as generally indicated at 51, surrounding the handle shaft. As the Belleville washers are compressed, they apply a resilient axial load to the outer end of sleeve 20. As indicated at 53, sleeve 20 has an enlarged head on its inner end. Handle shaft 17 has a flange 54 integrally formed thereon. A clutch disc 55 is mounted on handle shaft 17 so as to be disposed between sleeve head 53 and flange 54. Clutch disc 55 has a plurality of curved tabs 55a extending axially toward drive gear 21. The drive gear has a plurality of matching curved slots 21a (best shown in FIG. 5) for receiving a corresponding tab 55a. In this manner, the drive gear is positively coupled to the clutch disc so that the two parts will rotate as a unit on shaft 17. It will be appreciated that neither clutch plate 55, nor drive gear 21 are affixed or keyed to handle shaft 17. A pair of friction washers, as best shown in FIG. 6 at 56a, 56b, is provided, one on each side of clutch disc 55, so that a friction washer bears against each face of the clutch plate. Preferably, these friction washers 56a, 56b are of a suitable friction material such as Gylon®, a fluorocarbon plastic material with or without fillers, available from Garlock, Inc. of Palmyra, N.Y. As indicated at 56c, a spacer is provided between drive gear 21 and head 53 on sleeve 20.

As star wheel 50 is turned on handle shaft 17 so as to compress Belleville washers 51, head 53 on the inner end of sleeve 20 presses the clutch disc 55 against handle shaft flange 54 such that the friction washers 56a, 56b frictionally grip the clutch plate therebetween and cause the clutch plate and drive gear 21 (which is coupled to the clutch plate by tabs 55a that are received in slots 21a in the drive gear) to rotate with the handle shaft. Thus, as the handle shaft is turned so as to wind line onto the reel spool 5, the drive gear 21 drives the pinion 23 which in turn drives the spool. As described, the one-way clutch 19a prevents rotation of the handle shaft in the opposite direction.

When line is forcefully pulled from spool 5, such as when fighting a fish, a back driving force is transmitted via the gear train to clutch disc 55a. When this back driving force is sufficient to overcome the friction force of the clutch disc 55 engaging the drive gear 21, the clutch disc and the drive gear will slip (rotate) with respect to the handle shaft 17 so that line may be pulled from spool 5. However, as the force pulling line from the spool decreases below the force necessary to overcome the friction force coupling the clutch disc to the drive gear, the drive gear will again be effectively coupled to the clutch disc and line will not be pulled from the spool. Of course, the amount of force required to result in such slippage of the clutch disc and the drive gear is dependent on the compressive force transmitted by Belleville washers 51 to the clutch disc. By increasing or decreasing the compression of the Belleville washers, the drag setting of the reel may be adjusted.

A second drive gear, as indicated at 57 in FIGS. 3 and 5, is mounted on shaft 17 for driving a line leveler (not shown) in the manner well known to those skilled in the art.

It is preferred that the handle shaft axis HA and the pinion shaft axis PA be maintained within a limited range of tolerances such that these axes are spaced from one another a predetermined distance and are parallel to one another (within a predetermined range of angular alignment) so that drive gear 21 and pinion gear 23 properly mesh with one another so as to smoothly and quietly operate. It will be appreciated that because the bores for bearings 19a, 19b journaling handle shaft 17 and the bores for bearings 27a, 27b journaling pinion shaft 25 are machined in a common component (i.e., in side cover 13, as shown in FIGS. 3 and 5, or in frame 3 as shown in FIG. 4), it is much easier to accurately control the location of the bores and the tolerances of the bores than if the bores had to be machined in two difference components (e.g., in both the side cover 13 and frame 3).

Further, it will be noted that bearing 19a is a needle bearing one-way roller clutch having relatively long roller elements 19a′ housed in cage 19a″. Such one-way roller clutches are commercially available, for example, from The Timken Company of Canton, Ohio. As shown in FIG. 3, a tubular bushing 20 is inserted into the bore of bearing 19a such that the tubular busing serves as the inner race of bearing 19a such that roller elements 19a′ contact the outer surface of bushing 20. The inner bore 20a of bushing 20 snugly receives handle shaft 17. Cage 19a″ has stepped down flange 19a′″ onto which the bore of drive gear 21 is pressed so that the concentricity of the drive gear, bearing 19a, and handle shaft 17 is insured as a unit. Preferably, but not necessarily essential to this invention, pinion gear 21 and pinion shaft 25 are of one-piece construction. If the pinion and its shaft are made as a unit and/or in one piece, the accuracy and concentricity of the pinion with respect to its shaft relative to the pinion shaft axis PA may be readily controlled and that tighter tolerances can be maintained, as compared to assembling these components from separate parts. This makes it easier to maintain the spacing and the alignment of the handle shaft axis HA relative to the pinion shaft axis PA.

It will be appreciated by those skilled in the art that since the bores receiving bearings 19a, 19b and 27a, 27b are all in single part (i.e., side cover 13 as shown in FIGS. 2, 3 and 5, or in frame 3 as shown in FIG. 4), these bores are more readily machined and their dimensions, axial positions, and parallelism (i.e., alignment with respect to one another) are more easily and accurately controlled and maintained as compared to prior art reels, such as shown in FIG. 1, where the bores for the bearings journaling the handle shaft and the bores for the bearings journaling the pinion shaft (or the spool shaft) are in two or three separate components, such as the reel frame 103, a screw cap 113, and side cover 121. While the bearings 19a, 19b journaling handle shaft 17 and bearings 27a, 27b are shown in FIG. 3 to be carried by side cover 13, an alternative (and perhaps even more preferred embodiment of the reel of this invention) is shown in FIG. 4 where such bearings are all mounted solely with respect frame 3. In either embodiment, however, where the bearings are mounted solely with respect to either the side cover 13 or are mounted solely with respect to frame 3, such single element mounting of the bearings greatly facilitates machining of the bores receiving such bearings and insures that such bores are maintained within a more narrow range of tolerances so as to more readily hold the concentricity of such bores within a desired range.

Also, by journaling the above-said shafts only with respect to a single body (i.e., either with respect to side cover 13 or to frame 3), the accuracy with which the side cover must be mounted on the frame is lessened in order to insure proper alignment and parallelism between the handle shaft axis HA and the pinion shaft axis PA. This, in turn, results in a reel having quiet and smooth operation of the gear train and insures that the spool is free to rotate during casting.

It will also be noted that spool shaft 7 of the preferred embodiment shown in FIGS. 2 and 3 need not have an elongate end (similar to spool shaft end 107a, as shown in FIG. 1), and that pinion shaft 25 need not have an axial bore therethrough that receives the spool shaft extension. Preferably, but not necessarily, spool 5 and spool shaft 7 are machined as a one-piece part. It will be appreciated that if spool 5 and spool shaft 7 are machined as one piece, the accuracy of the parts may better be controlled. As shown in FIG. 3, pinion shaft 25 is solid. Also, it will be noted that the spool shaft 7 terminates just outside of bearing 9a and that the spool shaft lacks an elongate spool shaft extension similar to extension 107a shown in FIG. 1. Because spool shaft 7 lacks an elongate extension similar to extension 107a, as shown in FIG. 1, assembly of the spool 5 into frame 3 requires alignment of only two bearings 9a, 9b, rather than the alignment of three bearings, as shown in FIG. 1. Thus, assembly and alignment of the spool in the reel is much easier and faster.

As noted, coupler 29 connects the output end of pinion shaft 25 to spool shaft 7 so that the spool is driven by the gear train. Coupler 29 accommodates both axial misalignment between spool axis SA and pinion axis PA and axial variances (offset) between the pinion shaft and the spool shaft within limited ranges. The use of such a coupler that accommodates such misalignment and variances greatly lessens the criticality of the tolerances of the mounting of the bearings in the frame and side cover. It will be appreciated that with prior art reels, such as shown in FIG. 1, where the spool shaft extension 107a is received within the bore 135 of pinion shaft 133, the spool shaft extension supports and journals pinion 133.

Coupler 29 has a first end bore 31 that is slidably received on the inner end of pinion shaft 25. The coupler further has a second end bore 33 that receives the end of spool shaft 7 and is coupled to the spool shaft for rotatably driving the spool. Preferably, bore 31 is slidably connected by a pin and slot arrangement (not shown) to pinion shaft 25 so that the coupler rotates with the pinion shaft and so that the coupler may be moved axially along the pinion shaft for moving end 33 in axial direction toward and away from the end of spool shaft 7. As indicated at 35, a pin extends diametrically through the end of spool shaft 7. The coupler 29 has notches (not shown in FIGS. 3 or 5) in its end face that receive pin 35 thereby to operatively couple the pinion shaft 25 to the spool shaft 7 so that the spool may be driven by the speed increasing gear train. A thumb bar mechanism (not shown) similar to thumb bar clutch mechanism 141 described above in regard to the prior art reel shown in FIG. 1 is operable to move coupler 29 in axial direction so as to move coupler end 33 clear of pin 35 thereby to uncouple the gear train from the spool thus allowing the spool to free wheel during a cast. Those skilled in the art are familiar with such thumb bars will appreciate that they operate to disengage and to engage the spool with respect to the drive gear train. Thumb bar and its clutch may be of any conventional design, such as described in U.S. Pat. No. 5,275,352, which is herein incorporated by reference.

As is conventional, after a cast, rotation of the handle 15 to take up line on the spool 5 causes the thumb bar mechanism or clutch to move the pinion shaft 25 in axial direction toward spool 5 so that the notches in the end face of coupler end 33 engage pin 35. In this manner, the handle and gear train are automatically reengaged with the spool upon the use operating the handle to take up line onto the reel. It will be appreciated the above-described coupler and its splined connection to pinion shaft 25 accommodate differences in axial dimensions, angular misalignment, and locations between the ends of the pinion shaft and the spool shaft. Coupler 29 may be made of a suitable flexible plastic that will bend between its end portions 31 and 33 so as to better accommodate, within a limited range, angular misalignment and dimensional variances between the pinion shaft and the spool shaft. Further, coupler 27 may act as a universal joint coupling pinion shaft 25 to spool 7 thus further accommodating such angular misalignment and dimensional variances. It will be further understood that coupler 27 may be integral with pinion shaft 25 such that only one connection to spool shaft 7 is needed, and such that the pinion shaft may be shifted axially with respect to its bearings 27a, 27b so as operatively disconnect the pinion shaft from spool shaft 7. It is also contemplated that coupler 29 may not be needed to operatively connect pinion shaft 25 to spool shaft 7, but instead this may be accomplished by forming one or more diametric notches in the end face of pinion shaft 25 and by providing a blade end (similar to a screwdriver blade) on the end of spool shaft 7 such that as a clutch mechanism (thumb bar) moves pinion shaft in axial direction, the notches in the end face of the pinion shaft may be moved clear of the blade end of the spool shaft thereby to disconnect the spool from the drive train. Upon operating handle 15 so as to wind line onto spool 7, such prior clutch mechanism will effect axial movement of pinion shaft toward the spool such that pin 35 will be gripped by the notches in the end of pinion shaft 25 thereby to connect the spool to the pinion and to thus permit the speed increasing gear train to drive the spool for retrieval of line onto the spool.

As generally indicated at 37 in FIGS. 3 and 5, a cast control is provided on the side of the reel from handle 13 so as to adjustably increase or decrease frictional drag on spool 3 thereby to inhibit overrunning of the spool upon the lure landing after a cast and to thus minimize the tendency to form line tangles (back lashes). As shown in FIG. 3, cast control 37 comprises a friction member 39 held against rotation and having a beveled recess 41 that receives a corresponding beveled end 43 of spool shaft 7. The friction member is housed in a cast control housing 45 having a hollow hub 47 that receives the friction member so that the friction member is movable axially in the hub toward and away from the beveled end 43 of spool shaft 7. The friction member is resiliently biased in axial direction toward the end of the spool shaft by means of a spring 49, preferably (but not necessarily) a compression coil spring, located within the hollow hub 47. For example, in place of a coil spring, spring 49 may be a leaf spring, a stack of Bellville washers, or a resilient compressible material (such as a suitable elastomeric material) may be used in place of a compression coil spring to bias friction member 39 toward the adjacent end 43 of spool shaft 7. Cast control housing 45 is threaded into screw cap 11. In turn, screw cap 11 has an inner hub 81 that receives cast control hub 47 and that receives spool bearing 9b. It will also be noted that inner hub 81 receives bearing 9b that journals one end of spool shaft 7.

Screw cap 11 further has an outer hub 83 that is threadably received within a threaded opening in frame 3 so that, in effect, screw cap 11 and frame 3 are joined so that spool bearing 9b is, in effect, journaled with respect to the frame. With spring 49 mounted within hub 47, the spring may be adjustably compressed or relaxed so as to add or remove frictional drag on the end of the spool shaft 7 by threadably adjusting cast control member 45 relative to screw cap. It will be appreciated that this arrangement gives a wider range of adjustment than the prior art cast controls, as described in regard to FIG. 1, that use a disc to engage the end of the spool shaft. It will be appreciated that with such prior art cast controls that use a flexible disc to frictionally engage the end of the spool shaft that the spool shaft must be accurately located relative to the flexible disc in order for the disc to exert force on the end of the spool shaft. However, the provision of spring 47 biasing friction member 39 toward the end of the spool shaft accommodates a wider range of axial positions of the end of the spool shaft with respect to the friction member with little or no difference in the frictional force that the friction member may exert on the spool shaft. Further, the provision of beveled recess 41 in friction member 39 in engagement with the beveled end 43 of spool shaft 7 provides a relatively large surface area for generating friction between the friction member and the end of spool shaft 7. These structural differences between cast control 37 of the present invention and the prior art cast controls, as shown in FIG. 1, are much less sensitive to axial dimensional variations of the cast control friction member 39 and the adjacent end of spool shaft 7, and are operable over a wider degree of adjustment. In this manner, even if the right-hand end of the spool shaft is out of position be a considerably amount (e.g., about 1/10^{th} inches or more), the cast control will nevertheless still apply the desired amount of drag on the reel and will be adjustable substantially throughout its full range of adjustment. A flip-up tab 85 is carried on the outside of cast control housing 41 so that the cast control housing may readily be adjusted (turned) by the user.

As generally indicated at 87, the end of spool 7 facing toward cast control 33 carries a centrifugal brake member having brake shoes (not shown) that are forced outwardly by centrifugal force during casting where the brake shoes frictionally engage a circular stationary brake drum (also not shown) carried by frame 3. Such centrifugal braking systems are well known to those skilled in the art and are not part of the present invention.

Referring now to FIG. 4, a semi-diagrammatic illustration of a reel frame on another embodiment of the present invention is shown in its entirety at 61. In reel frame 61, all of the major rotating components on the handle side of the reel are journaled solely with respect to the reel frame. Frame 61 includes a main body 63 having spaced side frame members 65a, 65b between which spool 5 (similar to that shown in FIGS. 3 and 5, but not shown in FIG. 4) is rotatably supported (journaled) in suitable bearings (not shown in FIG. 4, but similar to bearings 9a, 9b shown in FIGS. 3 and 5). Frame 61 has a frame extension 67 extending from one side of the main body 63 facing the reel handle. The frame extension 67 has bosses 69 and 71 for rotatably supporting handle shaft 17 and pinion shaft 25. Preferably, but not necessarily, the above-described frame components 63, 65a, 65b, 67, 69 and 71 are cast as a one-piece frame of a suitable material, such as magnesium, aluminum, or molded of a suitable rigid plastic. Those skilled in the art will recognize that frame 61 will be designed to as to be housed within a reel having a desired shape so as to result in reel having desired aesthetic and ergonomic attributes.

As indicated at 73, side frame member 65b has a bore formed therein of sufficient diameter that the side flanges 5a, 5b of spool 5 may be axially inserted therethrough. Although not shown in FIG. 4, side frame member 65a has a recess in its side facing the spool of a diameter similar to the diameter of bore 73 for receiving spool flange 5b such that there is a close fit between the spool side flange 5b and bore 73 and between spool side flange 5a so that the spool is able to freely rotate, but yet to have a sufficiently close fit so as to prevent fishing line wound on the spool from entering the gaps between the spool side flanges 5a, 5b and bore 73 and the recess (not shown) in side frame member 65a.

Referring now to frame boss 69, a bore 75 is provided therethrough. Bore 75 is adapted to receive a one-way roller clutch bearing (not shown in FIG. 4) similar to clutch bearing 19a shown in FIG. 3. It will be appreciated that the one-way roller clutch bearing is of sufficient length that only this one bearing is needed to journal handle shaft 17. However, if desired, an additional frame boss (not illustrated) may be provided on frame 61 having a bore in axial alignment with handle shaft HA for receiving a bearing similar to bearing 19b, as shown in FIG. 3, so that the handle shaft is journaled by two bearings.

Further, boss 69 has a pinion shaft bore 77 therein, through which pinion axis PA extends. Boss 71 has a bore 79 therethrough in axial alignment with bore 77 and pinion axis PA extends through bore 79. Bores 77 and 79 are adapted to receive pinion bearings 27a, 27b, in the manner shown in FIG. 3. It will be particularly noted in FIG. 4 that pinion axis PA is coaxial with shaft axis SA. The pinion shaft 25 may be operatively coupled to spool shaft 7 by a coupler, similar to coupler 33 described above in regard to FIG. 3. Boss 65a has a bore 81 formed therethrough for receiving spool bearing 9a, with spool shaft 7 extending out beyond bearing 9a, as shown in FIG. 3.

Those skilled in the art will recognize that the end of spool shaft 7 proximate boss 65b may be journaled by a bearing 9b mounted in screw cap 11 in the manner shown in FIG. 3.

It will be appreciated that with frame 61 cast as a one-piece member with bores 73, 81, 79, 77, and 75 cast in bosses 65b, 65a, 71, and 69, respectively, these bores may be readily machined to desired finished dimensions along the two axes HA and PA/SA.

Those skilled in the art will understand that in a reel, as shown in FIGS. 2, 3 and 5 where the bearings for the handle shaft 17 and the bearings for the pinion shaft 25 are journaled solely with respect to side cover 13, and that in a reel having utilizing frame 61 (as shown in FIG. 4) where the bearings for the handle shaft 17 and the bearings for the pinion shaft 25 and at least one bearing for spool shaft 7 are journaled solely with respect to frame 61, it is easier and less costly to achieve the close tolerances necessary to properly journal these shafts, and to maintain alignment and a parallel relation between these shafts so that the reel will exhibit less gear noise and will be smooth in operation. It will be appreciated that because the bores for the bearings journaling these shafts are mounted in a single member (i.e., in either side cover 13 or frame 61), this single member need only be placed in a machining fixture one time during machining and that the bores can be precision machined in a CNC machining center (or other machine tool) without having to re-position or refixture the part in the machining center. This results in improved machining tolerances for the bores receiving the bearings that are coaxial with respect to one another and that must be maintained in a desired parallel relation relative to one another with little or no angular misalignment of these bores. Also, the spacing between the handle axis HA and the pinion axis PA is more readily and more accurately maintained such that gear noise generated by the drive gear 21 and pinion 23 is minimized. Of course with prior reels where the bores for the bearings journaling the handle shaft and the pinion shaft are in two different parts (i.e., side cover 13 and frame 3), it is necessary that the parts be mounted separately in the machine tools used to machine these bores, or that the bores may be formed in different machines. Those skilled in the art will appreciate that if a part has to be repositioned to machine part of those critical bore relationships, the issues of fixture repeatability, shifting of the part on the fixture, warpage due to different clamping pressures all degrade the overall final accuracy of the machined part. The one piece journaling of the two shafts allows for the part and all its critical bores to be finish machined in a single fixturing (clamping) of the part.

Of course, by providing a frame 61 where the major components of the reel, as described above, are journaled solely with respect to the frame and not to the frame and one or more side covers, or by providing a side cover 13 where such shafts are journaled solely with respect to the side cover, the position of the side cover on the reel frame is not critical, as compared to the necessity of accurately positioning the side cover with respect to the frame as is the case in prior art reels, as shown in FIG. 1, where the handle shaft and the pinion shaft are journaled both in the side cover and the frame. It will be understood that that the side cover 13 on the handle side of the reel may be removed without having to disassemble components of the gear train and without having to remove bearings from their respective bores. This facilitates assembly of the reel and allows the user to more readily dis-assemble the reel for cleaning. Still further, cast control 37 of the present invention, the need for a spool shaft extension (similar to spool shaft extension 107a, as shown in FIG. 1) is eliminated. This results in a spool that is only journaled with respect to the reel frame, and not with respect to the reel frame and the side cover.

While the present invention has been described by reference to specific embodiments, it should be understood that modifications and variations of the invention may be constructed without departing from the scope of the invention defined in the following claims. It will also be appreciated that not all of the above-described and apparent features and objects need be embodied in the structure and method described in the claims below.

What is claimed is:

1. In a fishing reel having a frame, at least one side cover adapted to be secured to said frame, a handle shaft, a drive gear rotatably driven by said handle shaft, a pinion in mesh with said drive gear, a pinion shaft, a spool shaft, and a spool carried by said spool shaft and driven by said pinion, wherein the improvement comprises: said handle shaft and said pinion shaft being carried by and being journaled solely with respect to said side cover, said spool shaft having an end proximate said pinion, said spool shaft proximate end being journaled solely with respect to said frame, and a coupler for operatively connecting said pinion shaft to said proximate end of said spool shaft so that said coupler can accommodate both axial dimensional variances and angular misalignment variances within a limited range between said pinion shaft and said spool shaft.

2. In a fishing reel as set forth in claim 1 having a handle fixedly secured to said handle shaft.

3. In a fishing reel as set forth in claim 1 wherein said handle shaft is journaled with respect to said side cover by a one-way clutch.

4. In a fishing reel as set forth in claim 1 wherein said drive gear and said pinion gear are helical gears.

5. In a fishing reel as set forth in claim 1 wherein said spool shaft has another end distal from said drive gear and said pinion, and wherein said reel further has a cast control engageable with said distal end of said spool shaft so as to apply drag to said spool during a cast, said cast control comprising a friction member engageable with said distal end of said spool shaft, a spring biasing said friction member into engagement with said spool shaft, and an adjustment member for adjustably increasing or decreasing the force said spring applies to said friction member and in turn for adjustably increasing or decreasing the force that said friction member applies to said spool shaft.

6. In a fishing reel as set forth in claim 5 wherein said adjustment member is threadably adjustable with respect to said frame.

7. In a fishing reel as set forth in claim 6 wherein said distal end of said spool shaft is beveled, and wherein said friction member has a complimentary beveled recess therein for receiving said beveled spool shaft end thereby to frictionally engage said spool shaft.

8. In a fishing reel as set forth in claim 1 having a drag assembly interposed between said spool and said drive gear such that upon applying a force above a predetermined amount on said line wound onto said spool, said drive gear is uncoupled from said handle shaft so as to permit line to be unwound from said spool.

9. A fishing reel having a frame, a side cover, a spool on which a supply of line is wound, a spool shaft, a speed increasing gear train, the latter comprising a handle shaft operated by a handle, a drive gear mounted on said handle shaft, a pinion in mesh with said drive gear, a pinion shaft on which said pinion is mounted, wherein said handle shaft and said pinion shaft are journaled solely with respect to said cover, and a coupler operatively connecting said pinion shaft and a proximate end of said spool shaft so as to accommodate a range of dimensional variances and angular misalignment between said pinion shaft and said spool.

10. A fishing reel as set forth in claim 9 wherein said proximate end of said spool is journaled solely on said frame.

11. A fishing reel having a frame and at least one side cover, a spool rotatably journaled with respect to said frame, a spool shaft, a handle, a gear train operatively connecting said handle and said spool shaft so that upon rotation of said handle said spool is rotated to wind line onto said reel, and a cast control for inhibiting said spool from overrunning the withdrawal of line therefrom during a cast, said cast control being located on the side of the reel opposite said handle and comprising a friction member engageable with an end of said spool shaft distal from said gear train, a cast control adjustment member, and a spring interposed between said cast control adjustment member and said friction member so that said spring biases said friction member into engagement with said distal end of said spool shaft and thus applies a desired friction force to said spool shaft.

12. A fishing reel as set forth in claim 11 wherein said friction member is held against rotation with respect to said frame.

13. A fishing reel as set forth in claim 11 wherein said distal end of said spool shaft is beveled and said friction member has a beveled bore engageable with said beveled end of said spool shaft.

14. In a fishing reel having a frame, a handle shaft, a drive gear rotatably driven by said handle shaft, a pinion in mesh with said drive gear, a pinion shaft, a spool shaft, and a spool carried by said spool shaft and driven by said pinion, wherein the improvement comprises: said handle shaft and said pinion shaft being carried by and being journaled solely with respect to said frame, said spool shaft having an end proximate said pinion, said spool shaft proximate end being journaled with respect to said frame, and a coupler for operatively connecting said pinion shaft to said proximate end of said spool shaft so that said coupler can accommodate both axial dimensional variances and angular misalignment variances within a limited range between said pinion shaft and said spool shaft.

15. In a fishing reel as set forth in claim 14 further comprising a side cover enclosing the side of said frame proximate said handle.

16. In fishing reel as set forth in claim 14 wherein said spool has a spool axis and said pinion shaft has a pinion axis, and wherein said spool axis and said pinion shaft are substantially coaxial.

17. In a fishing reel having a frame, at least one side cover adapted to be secured to said frame, a handle shaft, a drive gear rotatably driven by said handle shaft, a pinion in mesh with said drive gear, a pinion shaft, a spool shaft, and a spool carried by said spool shaft and driven by said pinion, wherein the improvement comprises: said handle shaft and said pinion shaft being carried by and being journaled solely with respect to said side cover, or being carried by and being journaled solely with respect to said frame, said spool shaft having an end proximate said pinion, said spool shaft proximate end being journaled solely with respect to said frame, and a coupler for operatively connecting said pinion shaft to said proximate end of said spool shaft so that said coupler can accommodate both axial dimensional variances and angular misalignment variances within a limited range between said pinion shaft and said spool shaft.

18. A method of driving a spool of a fishing reel by means of a gear train having an input shaft and an output shaft, said input shaft having an input shaft axis, said output shaft having an output shaft axis, and said spool having a spool axis, said reel having a frame, where axial misalignments and dimensional variances between all of said axes are controlled only with respect to said frame, said spool being operatively connected to said gear train so as wind line onto said spool upon operation of said gear train, said spool shaft having an end proximate said gear train, said method comprising the steps of:
(a) journaling said input shaft solely with respect to said frame;
(b) journaling said output shaft solely with respect to said frame; and
(c) journaling said proximate end of said spool shaft solely with respect to said frame.

19. A method of driving a spool of a fishing reel by means of a gear train having an input shaft and an output shaft, said input shaft having an input shaft axis, said output shaft having an output shaft axis, and said spool having a spool axis, said reel having a frame and a side cover, where axial misalignments and dimensional variances between of said input and output axes are controlled only with respect to said side cover, said spool having a spool shaft with one end thereof proximate said gear train being operatively connected to said gear train so as wind line onto said spool upon operation of said gear train, said method comprising the steps of:
(a) journaling said input shaft solely with respect to said side cover;
(b) journaling said output shaft solely with respect to said side cover; and
(c) journaling said proximate end of said spool shaft solely with respect to said frame; and
(d) coupling said output shaft to said proximate end of said spool so as to accommodate dimensional variances and angular misalignments between said output shaft and said spool shaft within a limited range.

20. A method of driving a spool of a fishing reel by means of a gear train having an input shaft and an output shaft, said input shaft having an input shaft axis, said output shaft having an output shaft axis, and said spool having a frame, side cover, a spool axis, said reel having a frame, where axial misalignments and dimensional variances between all of said axes are controlled within a predetermined limited range, said spool being operatively connected to said gear train so as wind line onto said spool upon operation of said gear train, said spool shaft having an end proximate said gear train, said method comprising the steps of:
(a) journaling said input shaft solely with respect to said frame, or solely with respect to said side cover;
(b) journaling said output shaft solely with respect to said frame, or solely with respect to said side cover;
(c) journaling said proximate end of said spool shaft with respect to said frame; and
(d) coupling said output shaft to said spool shaft so as to accommodate axial misalignment and dimensional variances between the axes of said output shaft and said spool shaft within a limited range.
